(19) United States
(12) Patent Application Publication
(10) Pub. No.: US 2016/0381011 A1
(43) Pub. Date: Dec. 29, 2016

(54) NETWORK SECURITY METHOD AND NETWORK SECURITY SYSTEM

(71) Applicant: Datong Mu, Beijing (CN)

(72) Inventor: Datong Mu, Beijing (CN)

(21) Appl. No.: 15/039,884

(22) PCT Filed: Jan. 8, 2015
(86) PCT No.: PCT/CN2015/070331

§ 371 Date: May 27, 2016

(30) Foreign Application Priority Data
Jan. 22, 2014 (CN) 201410031316.7

(51) Int. Cl. H04L 29/06; H04W 12/04; H04L 9/32; H04W 12/06

(52) U.S. Cl. CPC H04L 63/0853; H04W 12/06; H04L 63/0869; H04L 63/083; H04L 63/0245; H04L 63/062; H04W 12/04; H04L 9/321; H04L 9/3247

(57) ABSTRACT

Disclosed are a network security method and a network security system. The method comprises steps: a third-party server, an application server, a mobile terminal and a client host being started and running respective read-only software; an application IC card transmitting an input user password to the application server; the application server and the client host respectively starting data packet filtering; the mobile terminal executing encryption and decryption computations of encrypted Internet communication of the client host; the client host directly logging in the application server and transmitting a user command to the application server; the mobile terminal and/or the application IC card confirming the user command with the application server; and the mobile terminal and/or a third-party IC card generating a user command digital signature. The system comprises the application IC card, the mobile terminal, the client host, the application server, the third-party IC card and the third-party server.

### BACKGROUND OF THE INVENTION

Technical Field

The present invention relates to the technical field of Internet technologies and information security, in particular to a network security method and a network security system.

Description of Related Art

Development of Internet brings various network security problems, for example, Trojan viruses are used to steal sensitive user information such as user password at the client-ends of users; network fishing is employed to perform Internet fraud; through remote control over the user clients, data and operation of a user are falsified, a great amount of clients are invaded and controlled, and then DDoS attack s made, etc.

Therefore, the present invention provides a network security method and a network security system to solve the above problems.

### BRIEF SUMMARY OF THE INVENTION

The technical problem to be solved by the present invention is to provide a network security method and a network security system for executing network applications based on an application IC card, a mobile terminal, a client host, an application server, a third-party IC card and a third-party server, to improve the security of network applications.

The present invention adopts the following technical solutions to solve the technical problems.

A network security method includes the following steps:

step A, a third-party server, an application server, a mobile terminal and a client host are respectively started and run respective system software and application software memorized in read-only mode;

step B, an application IC card transmits an input user password to the application server through the mobile terminal, while the mobile terminal allows the mobile terminal to log in;

step C, the application server and the client host respectively acquire network parameters of each other through the mobile terminal, and start data packet filtering based on own and mutual network parameters;

step D, the application server transmits a session secrete key of encrypted Internet communication with the client host to the mobile terminal, while the mobile terminal executes encryption and decryption computations of the encrypted Internet communication of the client host on the basis of the session secrete key;

step E, the client host logs in the application server in a mode of without using a username and a user password and transmits a user command to the application server, or transmits the user command to the application server in the status of not logging in the application server yet;

step F, the mobile terminal and/or the application IC card confirms the user command with the application server; and,

step G, the mobile terminal and/or a third-party IC card generates a user command digital signature.

The method has the beneficial effect of ensuring terminal-to-terminal and user-to-user security of network applications.

Based on the above technical solution, the network security method can be improved in the following way:

Further, step A includes the following: after startup, the third-party server reads and runs third-party server system software and third-party server application software which are memorized in read-only form; after startup, the application server reads and runs application server system software and application server application software which are memorized in read-only form; after startup, the mobile terminal reads and runs mobile terminal system software and mobile terminal application software which are memorized in read-only form by the mobile terminal, application IC card and/or third-party IC card; after startup, the client host read and runs client host system software and client host application software which are memorized in read-only form by the client host, mobile terminal, application IC card and/or third-party IC card.

The above improved solution has the beneficial effect of preventing computer viruses from endangering network application.

Further, in step A, the client host reads the mentioned software of the application IC card and/or the third-party IC card through the mobile terminal, or reads the mentioned software of the application IC card and/or the third-party IC card directly through the NFC.

Further, step B includes the following: the application IC card establishes NFC communication with the mobile terminal; the application IC card prompts a user to enter the user password to the application IC card, executes mutual authentication and establishes encrypted communication with the application server through the mobile terminal, and transmits the input user password to the application server in form of encrypted communication; and the application server establishes encrypted communication with the mobile terminal, and allows the mobile terminal to log in.

The above improved solution has the beneficial effect of ensuring the truth of the user.

Further, step C includes the following: the application server and the client host respectively set respective network parameters, acquire the network parameters of each other through the mobile terminal, and respectively start the data packet filtering based on own and mutual network parameters, wherein the network parameters are IP address, TCP sequence No, TCP port and/or UDP port.

The above improved solution has the beneficial effect of preventing DDos attack from endangering the application server, and preventing network fishing from endangering the client host.

Further, step D includes the following: the application server generates a session secrete key K1 for the encrypted Internet communication with the client host and transmits K1 to the mobile terminal; the mobile terminal executes encryption and decryption computations of the encrypted Internet communication between the client host and the application server based on K1; and the client host establishes the encrypted Internet communication with the application server based on the encryption and decryption computations.

The above improved solution has the beneficial effect of improving the confidentiality of the encrypted Internet communication.

Further, step E includes the following: the application server generates a dynamic identifier and a dynamic password and transmits the dynamic identifier and the dynamic password to the client host through the mobile terminal; the client host transmits the dynamic identifier and the dynamic password to the application server; the application server allows the client host to log in; the client host transmits the user command which is input to the client host to the mobile terminal; the mobile terminal prompts to confirm the user command, and generates a user command ciphertext based on K1 after receiving the confirmation; the client host transmits the user command ciphertext to the application server, or the client host transmits the user command to the application server through the encrypted Internet communication in the status of not logging in the application server.

The above improved solution has the beneficial effect of preventing the client host from leaking sensitive user information during logging in; the mobile terminal confirms the user command which is transmitted by the client host to the mobile terminal, preventing the user command, which is falsified before being encrypted, from taking effect.

Further, step F includes the following: the application server transmits the user command back to the mobile terminal; the mobile terminal confirms that the user command transmitted back by the application server is correct; the application IC card executes mutual authentication with the application server through the mobile terminal; the mobile terminal prompts to input the user command to the mobile terminal or the application IC card, transmits the input user password to the application server, or the mobile terminal prompts a user to confirm the user command transmitted back by the application server and transmits the confirmation to the application server.

The above improved solution has the beneficial effect that, the mobile terminal confirms the user command, which is transmitted back to the mobile terminal, with the application server, preventing the user command, which is falsified after being encrypted, from taking effect.

Further, step G includes the following: the third-party IC card executes mutual authentication with the third-party server through the mobile terminal; the mobile terminal transmits the user command digital signature generated by the mobile terminal and/or the third-party IC card to the third-party server; the third-party server generates a time stamp of the user command digital signature and transmits the time stamp and the user command digital signature to the application server; and the application server executes the user command.

The above improved solution has the beneficial effect of ensuring the non-repudiation of the user command.

Further, in all steps of the network security method, the application IC card or the-party IC card can complete all functions of both parties independently; the application server or the third-party server can complete all functions of both parties independently; the mobile terminal can complete all functions of the client host; and the mobile terminal, the third-party IC card, the application IC card and the user password are bound with one another.

Corresponding to the network security method, the technical solution of the present invention also provides a network security system, including the application IC card, the mobile terminal, the client host, the application server, the third-party IC card and the third-party server.

The application IC card is connected with the mobile terminal through near field communication (NFC), is used for establishing NFC communication with the mobile terminal and prompting entry of the user password to the application IC card, executes mutual authentication with the application server through the mobile terminal, establishes encrypted communication, and transmits the input user password to the application server through the encrypted communication; the application IC card is used for executing the mutual authentication with the application server through the mobile terminal after the mobile terminal confirms that the user command fed back by the application server is correct.

The mobile terminal is connected with the application server and the third-party server through the mobile network, is connected with the client host through a wired communication interface or a wireless communication interface, or communicates with the client host through a QR code, and is used for reading and running mobile terminal system software and mobile terminal application software, which are memorized in read-only mode by the mobile terminal, application IC card and/or third-party IC card, after startup; the mobile terminal is used for executing the encryption and decryption computations of the encrypted Internet communication between the client host and the application server based on the session secrete key K1; the mobile terminal is used for promoting confirmation of the user command transmitted by the client host, generating a user command ciphertext based on K1 after receiving the confirmation, and transmitting the user command ciphertext to the client host; the mobile terminal is used for, after confirming that the user command transmitted back by the application server is correct, promoting entry of the user password to the mobile terminal or the application IC card, transmitting the input user password to the application server, or promoting the user to confirm the user command transmitted back by the application server, and transmitting the confirmation to the application server; and the mobile terminal is used for transmitting the user command digital signature generated by the mobile terminal and/or the third-party IC card to the third-party server.

The client host is connected with the application server and the third-party server through a digital communication network, and after being started, is used for reading and running the client host system software and client host application software memorized in read-only mode by the client host, mobile terminal, application IC card and/or third-party IC card; the client host is used for setting network parameters of the client host, acquiring network parameters of the application server through the mobile terminal, starting the data packet filtering based on the network parameters of the client host and the application server, wherein the network parameters are IP address, TCP sequence number, TCP port and/or UDP port; the client host is used for establishing the encrypted Internet communication with the application server based on the encryption and decryption computations of the mobile terminal; the client host is used for transmitting a dynamic identifier and a dynamic password to the application server, logging in the application server, transmitting the user command input to the client host to the mobile terminal, and transmitting the user command ciphertext generated by the mobile terminal to the application server, or the client host transmits the user command to the application server through the encrypted Internet communication in the status of not logging in the application server.

The application server is connected with the third-party server through a data communication network, and after being started, is used for reading and running the application server system software and application server application software thereof memorized in read-only mode; the application server is used for establishing encrypted mobile communication with the mobile terminal and allowing the mobile terminal to log in; the application server is used for setting network parameters of the application server, acquiring the network parameters of the client host through the mobile terminal, and starting the data packet filtering based on the network parameters of the application server and the client host, wherein network parameters are IP address, TCP sequence number, TCP port and/or UDP port; the application server is used for generating the session secrete key K1 of the encrypted Internet communication between the application server and the client host, and transmitting K1 to the mobile terminal; the application server is used for generating the dynamic identifier and the dynamic password, transmitting the dynamic identifier and the dynamic password to the client host through the mobile terminal; the application server is used for transmitting the user command back to the mobile terminal; and the application server is used for executing the user command.

The third-party IC card is connected with the mobile terminal through the NFC, is used for executing mutual authentication with the third-party server through the mobile terminal, and is used for generating the user command digital signature.

The third-party server is used for reading and running the third-party server system software and the third-party server application software thereof memorized in the read-only mode after being started; and, the third-party server is used for generating the time stamp of the user command digital signature, and transmitting the time stamp and the user command digital signature to the application server.

The system has the beneficial effect of ensuring terminal-to-terminal and user-to-user security of network applications.

Based on the above technical solution, the network security system can be improved in the following way.

Further, in the network security system, the application IC card or the-party IC card can complete all functions of both parties independently; the application server or the third-party server can complete all functions of both parties independently; the mobile terminal can complete all functions of the client host; and the mobile terminal, the third-party IC card, the application IC card and the user password are bound with each other.

Further, in the network security system, a USB Key or a wearable smart device can be used to complete all functions of the application IC card and the third-party IC card, wherein the wearable smart device may be a smart watch, a smart band or smart goggles.

Further, the mobile terminal may be any one of mobile phone, PDA, tablet computer or notebook computer.

Further, the application IC card and/or third-party IC card includes a touch screen, the touch screen is used for displaying and receiving information, and the application IC card and/or third-party IC card can be set to work after the touch screen receives a correct passsword, and the touch screen is powered through NFC.

The above improved solution has the beneficial effect of improving the confidentiality of the IC card.

Further, the wired communication interface is a USB, while the wireless communication interface is NFC, blue-tooth or WLAN; the data communication networks includes wide area network, metropolitan area network and local network; and the mobile terminal communicates with the application server in a voice, message or data mode.

The technical solution of the present invention has the following beneficial effect: the method and the system provided by the present invention ensure terminal-to-terminal and user-to-user security of the network applications.

### BRIEF DESCRIPTION OF THE SEVERAL VIEWS OF THE DRAWINGS

FIG. 1 is a structural view of a network security system in Embodiment 1 of the present invention.

FIG. 2 is a flowchart of a network security method in Embodiment 2 of the present invention.

FIG. 3 is a flowchart of step A of the network security method in Embodiment 2 of the present invention.

FIG. 4 is a flowchart of step B of the network security method in Embodiment 2 of the present invention.

FIG. 5 is a flowchart of step C of the network security method in Embodiment 2 of the present invention.

FIG. 6 is a flowchart of step D of the network security method in Embodiment 2 of the present invention.

FIG. 7 is a flowchart of step E of the network security method in Embodiment 2 of the present invention.

FIG. 8 is a flowchart of step F of the network security method in Embodiment 2 of the present invention.

FIG. 9 is a flowchart of step G of the network security method in Embodiment 2 of the present invention.

FIG. 10 is a flowchart of a network security method in Embodiment 4 of the present invention.

Description of the marks in the attached drawings:

101—application IC card, 102—mobile terminal, 103—client host, 104—application server, 105—third-party IC card, 106—third-party server.

### DETAILED DESCRIPTION OF THE INVENTION

The principle and characteristics of the present invention are described with reference to the attached drawings. Embodiments here are used for explaining the present invention, not limiting the scope of the present invention.

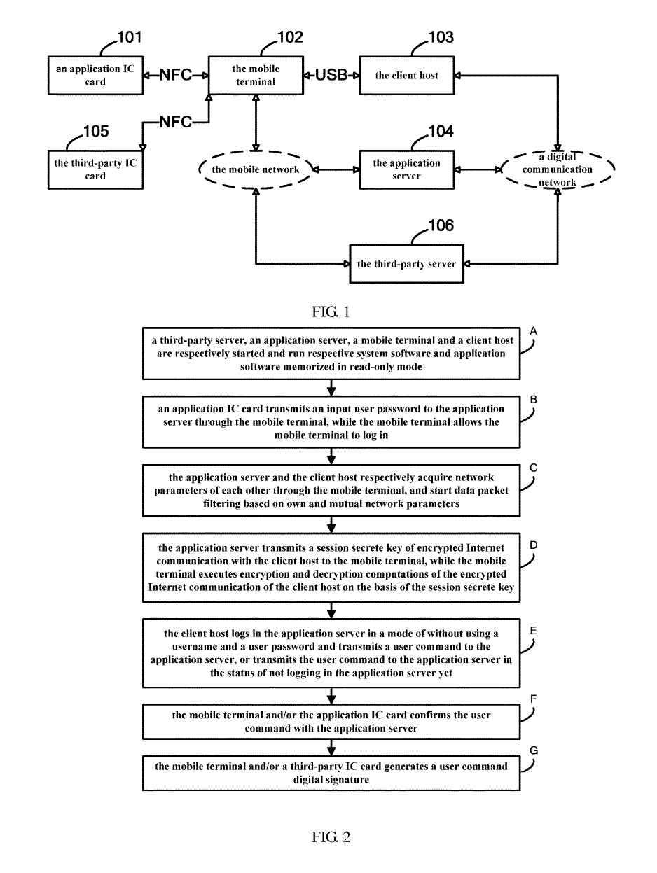

As shown in FIG. 1, Embodiment 1 provides a network security system, including an application IC card 101, a mobile terminal 102, a client host 103, an application server 104, a third-party IC card 105 and a third-party server 106.

The application IC card 101 is connected with the mobile terminal 102 through near field communication (NFC), is used for establishing NFC communication with the mobile terminal 102 and prompting entry of the user password to the application card 101, executes mutual authentication and establishes encrypted communication with the application server 104 through the mobile terminal 102, and transmits the input user password to the application server 104 through the encrypted communication; the application IC card is used for executing the mutual authentication with the application server 104 through the mobile terminal 102 after the mobile terminal 102 confirms that the user command fed back by the application server 104 is correct.

The mobile terminal 102 is connected with the application server 104 and the third-party server 106 through the mobile network, is connected with the client host 103 through a wired communication interface or a wireless communication interface, or communicates with the client host 103 through a QR code, and after being stated, is used for reading and running the system software and application software, which are memorized in read-only mode by the mobile terminal 102, application IC card 101 and/or third-party IC card 105, of the mobile terminal 102; the mobile terminal is used for executing the encryption and decryption computations of the encrypted Internet communication between the client host 103 and the application server 104 based on the session secrete key K1; the mobile terminal is used for promoting confirmation of the user command transmitted by the client host 103, generating a user command ciphertext based on K1 after receiving the confirmation, and transmitting the user command ciphertext to the client host 103; the mobile terminal is used for, after confirming that the user command transmitted back by the application server 104 is correct, promoting entry of the user password to the mobile terminal 102 or the application IC card 101, transmitting the input user command to the application server 104, or promoting the user to confirm the user command transmitted back by the application server 104, and transmitting the confirmation to the application server 104; the mobile terminal is used for transmitting the user command digital signature generated by the mobile terminal 102 and/or the third-party IC card 105 to the third-party server 106.

The client host 103 is connected with the application server 104 and the third-party server 106 through a digital communication network, and after being started, is used for reading and running the system software and application software, which are memorized in read-only mode by the client host 103, mobile terminal 102, application IC card 101 and/or third-party IC card 105, of the client host 103; the client host is used for setting network parameters of the client host 103, acquiring network parameters of the application server 104 through the mobile terminal 102, starting the data packet filtering based on the network parameters of the client host 103 and the application server 104, wherein the network parameters are IP address, TCP sequence number, TCP port and/or UDP port; the client host is used for establishing the encrypted Internet communication with the application server 104 based on the encryption and decryption computations of the mobile terminal 102; the client host is used for transmitting a dynamic identifier and a dynamic password to the application server 104, logging in the application server 104, transmitting the user command input to the client host 103 to the mobile terminal 102, and transmitting the user command ciphertext generated by the mobile terminal 102, or the client host 102 transmits the user command to the application server 104 through the encrypted Internet communication in the status of not logging in the application server 104.

The application server 104 is connected with the third-party server 106 through a data communication network, and after being started, is used for reading and running the system software and application software which are memorized in read-only mode, of the application server 104; the application server is used for establishing encrypted mobile communication with the mobile terminal 102 and allowing the mobile terminal 102 to log in; the application server is used for setting network parameters of the application server 104, acquiring the network parameters of the client host 103 through the mobile terminal 102, and starting the data packet filtering based on the network parameters of the application server 104 and the client host 103, wherein the network parameters are IP address, TCP sequence number, TCP port and/or UDP port; the application server is used for generating the session secrete key K1 of the encrypted Internet communication between the application server 104 and the client host 103, and transmitting K1 to the mobile terminal 102; the application server is used for generating the dynamic identifier and the dynamic password, transmitting the dynamic identifier and the dynamic password to the client host 103 through the mobile terminal 102; the application server is used for transmitting the user command back to the mobile terminal 102; and the application server is used for executing the user command.

The third-party IC card 105 is connected with the mobile terminal 102 through the NFC, is used for executing mutual authentication with the third-party server 106 through the mobile terminal 102, and is used for generating the user command digital signature.

The third-party server 106 is used for reading and running the system software and application software, wherein are memorized in the read-only mode, of the third-party server 106, after being started; and, the third-party server is used for generating the time stamp of the user command digital signature, and transmitting the time stamp and the user command digital signature to the application server 104.

As shown in FIG. 2, Embodiment 2 provides a network security method, including the following steps:

step A, a third-party server, an application server, a mobile terminal and a client host are respectively started and run respective system software and application software memorized in read-only mode;

step B, an application IC card transmits an input user password to the application server through the mobile terminal, while the mobile terminal allows the mobile terminal to log in;

step C, the application server and the client host respectively acquire network parameters of each other through the mobile terminal, and start data packet filtering based on own and mutual network parameters;

step D, the application server transmits a session secrete key of encrypted Internet communication with the client host to the mobile terminal, while the mobile terminal executes encryption and decryption computations of the encrypted Internet communication of the client host on the basis of the session secrete key;

step E, the client host logs in the application server in a mode of without using a username and a user password and transmits a user command to the application server, or transmits the user command to the application server in the status of not logging in the application server yet;

step F, the mobile terminal and/or the application IC card confirms the user command with the application server; and,

step G, the mobile terminal and/or a third-party IC card generates a user command digital signature.

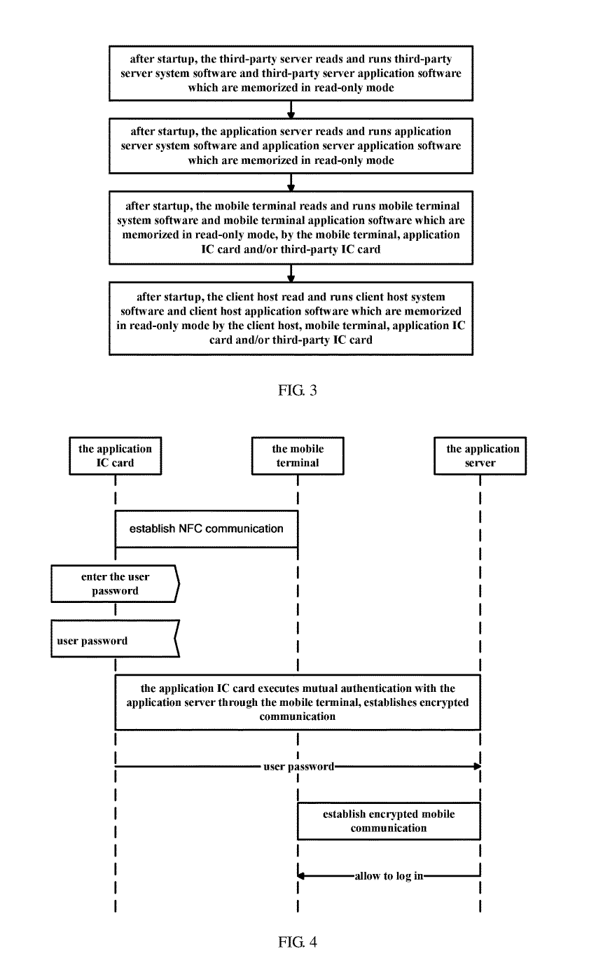

As shown in FIG. 3, in Embodiment 2, step A further includes the following: after startup, the third-party server reads and runs third-party server system software and third-party server application software which are memorized in read-only mode; after startup, the application server reads and runs application server system software and application server application software which are memorized in read-only mode; after startup, the mobile terminal reads and runs mobile terminal system software and mobile terminal application software, which are memorized in read-only mode, by the mobile terminal, application IC card and/or third-party IC card; after startup, the client host read and runs client host system software and client host application software, which are memorized in read-only mode, by the client host, mobile terminal, application IC card and/or third-party IC card.

As shown in FIG. 4, in Embodiment 2, step B further includes the following: the application IC card establishes NFC communication with the mobile terminal; the application IC card prompts a user to enter the user password to the application IC card, executes mutual authentication and establishes encrypted communication with the application server through the mobile terminal, and transmits the input user password to the application server in form of encrypted communication; and the application server establishes encrypted mobile communication with the mobile terminal, and allows the mobile terminal to log in.

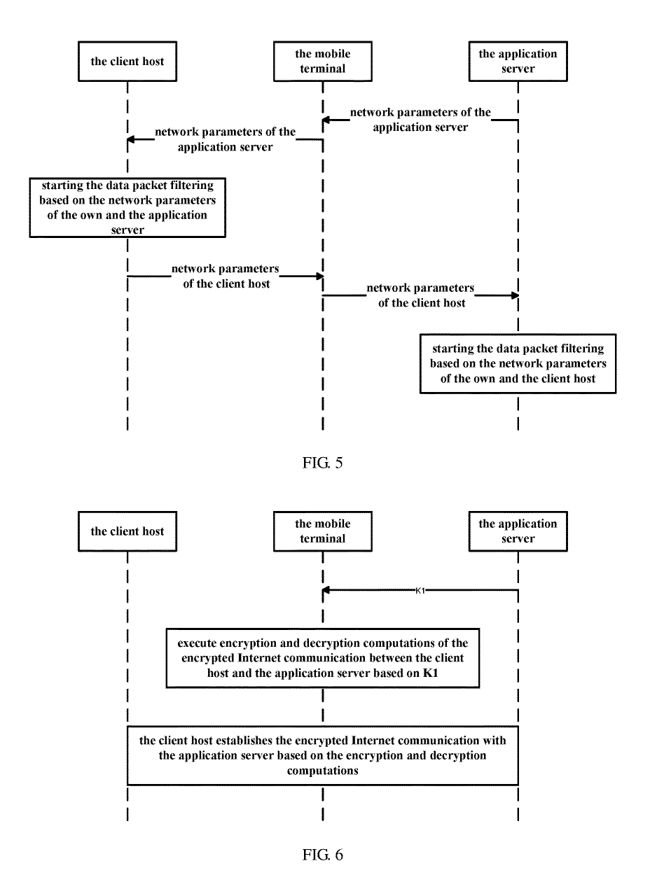

As shown in FIG. 5, in Embodiment 2, step C further includes the following: the application server and the client host respectively set respective network parameters, acquire the network parameters of each other through the mobile terminal, and respectively start the data packet filtering based on own and mutual network parameters, wherein the network parameters are IP address, TCP sequence No., TCP port and/or UDP port.

As shown in FIG. 6, in Embodiment 2, step D further includes the following: the application server generates a session secrete key K1 for the encrypted Internet communication with the client host and transmits K1 to the mobile terminal; the mobile terminal executes encryption and decryption computations of the encrypted Internet communication between the client host and the application server based on K1; and the client host establishes the encrypted Internet communication with the application server based on the encryption and decryption computations.

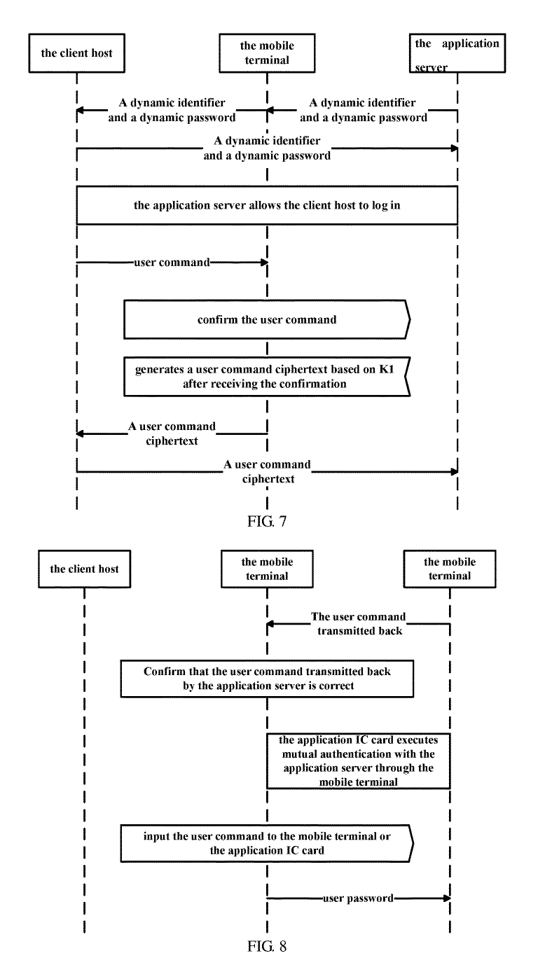

As shown in FIG. 7, in Embodiment 2, step E further includes the following: the application server generates a dynamic identifier and a dynamic password and transmit the dynamic identifier and the dynamic password to the client host through the mobile terminal; the client host transmits the dynamic identifier and the dynamic password to the application server; the application server allows the client host to log in; the client host transmits the user command which is input to the client host to the mobile terminal; the mobile terminal prompts to confirm the user command, and generates a user command ciphertext based on K1 after receiving the confirmation; the client host transmits the user command ciphertext to the application server, or the client host transmits the user command to the application server through the encrypted Internet communication in the status of not logging in the application server.

As shown in FIG. 8, in Embodiment 2, step F further includes the following: the application server transmits the user command back to the mobile terminal; the mobile terminal confirms that the user command transmitted back by the application server is correct; the application IC card executes mutual authentication with the application server through the mobile terminal; the mobile terminal prompts to input the user command to the mobile terminal or the application IC card, transmits the input user command to the application server, or the mobile terminal prompts a user to confirm the user command transmitted back by the application server and transmits the confirmation to the application server.

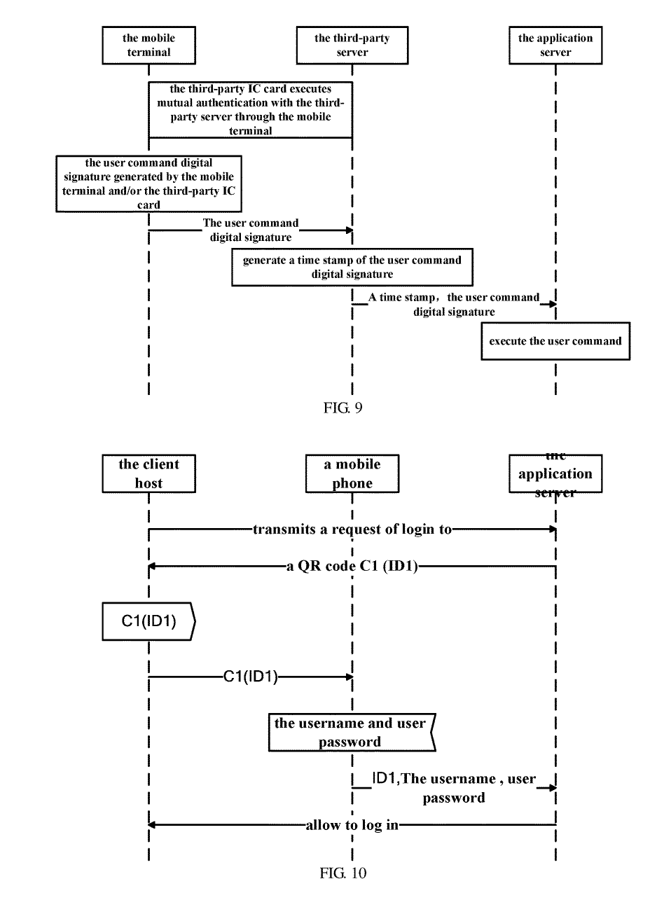

As shown in FIG. 9, in Embodiment 2, step G further includes the following: the third-party IC card executes mutual authentication with the third-party server through the mobile terminal; the mobile terminal transmits the user command digital signature generated by the mobile terminal and/or the third-party IC card to the third-party server; the third-party server generates a time stamp of the user command digital signature and transmits the time stamp and the user command digital signature to the application server; and the application server executes the user command.

A network security method is provided in Embodiment 3, including the following steps:

the client host transmits a request of login to the application server;

the application server generates the dynamic identifier ID1, generates a QR code C1 based on ID1 and transmits the C1 to the client host, and the client host reads ID1 from C1;

the client host displays C1; a mobile phone scans C1 and reads ID1 from C1; the mobile phone transmits the ICCID (Integrated Circuit Card Identity) of an SIM card thereof and DI1 to the application server;

the application server reads its memorized client host login username UserID corresponding to the ICCID, and enters the user password corresponding to the User ID to the mobile phone through prompt in the mobile phone;

the user password PW is input to the mobile phone, and the mobile phone transmits the PW to the application server;

the application server confirms that the received PW is correct, then generates a dynamic password ID2, generates a QR code C2 based on ID2, and transmits ID2 and C2 to the mobile phone;

ID2 is input to the client host or the client host reads C2 from the mobile phone and reads ID2 from C2, and the client host transmits the dynamic identifier ID1 and the dynamic password ID2 to the application server; and,

the application server confirms that the received ID1 and ID2 are correct, and then allows the client host corresponding to ID1 to log in with the login identity User ID.

In Embodiment 3, the client host logs in the application server in a mode of without using the username and user password, preventing the client host from leaking sensitive user information during login.

Besides, the client host and the mobile phone communicate with each other through NFC instead of the QR code.

As shown in FIG. 10, a network security method is provided in Embodiment 4, including the following steps:

the client host transmits a request of login to the application server;

the application server generates the dynamic identifier ID1, generates a QR code C1 based on ID1 and transmits the C1 to the client host;

the client host displays C1; the mobile phone scans C1 and reads ID1 from C1, inputs the username UserID and user password PW to the mobile phone, and the mobile phone transmits ID1, User ID and PW to the application server;

the application server confirms that the received User ID and PW are correct, and then allows the client host corresponding to ID1 to log in with the login identity User ID.

Besides, if the mobile phone has logged in the application server, the username and user password are not used in the above method, and the application server allows the client host corresponding to ID1 to log in with ID of mobile phone user after receiving the ID1 transmitted by the mobile phone.

Besides, the client host and the mobile phone communicate with each other through NFC instead of the QR code.

A network security method is provided in Embodiment 5, including the following steps:

after being started, the mobile phone reads and runs the mobile phone system software and mobile phone application software thereof memorized in read-only mode, and logs in the application server;

the client host transmits the user command input to the client host to the application server in the status of not logging in the application server;

the application server generates a sequence number according to the user command, generates a QR code C1 based on the sequence number and transmits C1 to the client host;

the client host displays C1, the mobile phone scans C1, reads the sequence number from C1 and transmits the sequence number to the application server;

the application server prompts the user command corresponding to the sequence number through the mobile phone, and prompts entry of the user password to the mobile phone to confirm the user command;

after confirming that the user command prompted in the mobile phone is correct, the user password is input to the mobile phone; the mobile phone transmits the user password to the application server, wherein the user password is bound with the mobile phone;

the application server judges that the user command belongs to the mobile phone user and executes the user command after confirming that the received user password is correct.

In Embodiment 5, the client host transmits the user command to the application server in the status of not logging in the application server, preventing the client host from leaking sensitive user information during logging in; the user command transmitted back to the mobile phone is confirmed by the application server through the mobile phone, preventing the user command, which is falsified during the Internet communication with the client host, from taking effect.

A remote payment method is provided in Embodiment 6, including the following steps:

an ID card executes mutual authentication with the third-party server through a POS terminal;

the third-party server transmits the ID of the ID card to the POS terminal;

the POS terminal transmits the ID and the sum of a business transaction to a payment server;

the payment server establishes mobile communication with the mobile communication through the ID, and inputs the payment password to the mobile phone through the prompt in the mobile phone to confirm the sum of the transaction business;

after the sum of the transaction business displayed in the mobile phone is correct, the payment password is input to the mobile phone; then the mobile phone transmits the payment password to the payment server;

the payment server transfers a sum of money equal to the sum of the transaction business from a payment account to a receipt bank account of the POS terminal, wherein the ID on the ID card, mobile phone, payment password and payment account are bound with one another.

In Embodiment 6, the ID card is used as the third-party IC card to start the remote payment, improving the compatibility of the remote payment.

A remote payment method is provided in Embodiment 7, including the following steps:

an ID card executes mutual authentication with the third-party server through a POS terminal;

the third-party server transmits the ID of the ID card to the POS terminal;

the payment password is input to the POS terminal; the POS terminal transmits the ID of the ID card, the payment password and the sum of a business transaction to the payment server;

the payment server transfers a sum of money equal to the sum of the transaction business from a payment account to a receipt bank account of the POS terminal, wherein the ID on the ID card, payment password and payment account are bound with one another.

In Embodiment 7, the ID card is used as the third-party IC card to start the remote payment, saving card issuing cost.

The above embodiments are only preferably embodiments of the present invention and shall not be regarded as limit of the present invention. Any modifications, equivalent changes and improvement made within the concept and principle of the present invention shall fall within the protective scope of the present invention.

1. A network security method, comprising the following steps:
step A, a third-party server, an application server, a mobile terminal and a client host being respectively started and running respective system software and application software memorized in read-only mode;
step B, an application IC card transmitting an input user password to the application server through the mobile terminal, while the mobile terminal allowing the mobile terminal to log in;
step C, the application server and the client host respectively acquiring network parameters of each other through the mobile terminal, and starting data packet filtering based on own and mutual network parameters;
step D, the application server transmitting a session secrete key of encrypted Internet communication with the client host to the mobile terminal, while the mobile terminal executing encryption and decryption computations of the encrypted Internet communication of the client host on the basis of the session secrete key;
step E, the client host logging in the application server in a mode of without using a username and a user password and transmitting a user command to the application server, or transmits the user command to the application server in the status of not logging in the application server yet;
step F, the mobile terminal and/or the application IC card confirming the user command with the application server; and,
step G, the mobile terminal and/or a third-party IC card generating a user command digital signature.

2. The network security method according to claim 1, characterized in that, step A further comprises: after startup, the third-party server reading and running third-party server system software and third-party server application software which are memorized in read-only form; after startup, the application server reading and running application server system software and application server application software which are memorized in read-only form; after startup, the mobile terminal reading and running mobile terminal system software and mobile terminal application software which are memorized in read-only form by the mobile terminal, application IC card and/or third-party IC card; after startup, the client host reading and running client host system software and client host application software which are memorized in read-only form by the client host, mobile terminal, application IC card and/or third-party IC card.

3. The network security method according to claim 1, characterized in that, step B further comprises: the application IC card establishing NFC communication with the mobile terminal; the application IC card prompting a user to enter the user password to the application IC card, executing mutual authentication and establishes encrypted communication with the application server through the mobile terminal, and transmitting the input user command to the application server in form of encrypted communication; and the application server establishing encrypted communication with the mobile terminal, and allowing the mobile terminal to log in.

4. The network security method according to claim 1, characterized in that, step C further comprises: the application server and the client host setting respective network parameters, acquiring the network parameters of each other through the mobile terminal, and respectively starting the data packet filtering based on own and mutual network parameters, wherein the network parameters are IP address, TCP sequence No, TCP port and/or UDP port.

5. The network security method according to claim 1, characterized in that, Step D further comprises: the application server generating a session secrete key K1 for the encrypted Internet communication with the client host and transmitting K1 to the mobile terminal; the mobile terminal executing encryption and decryption computations of the encrypted Internet communication between the client host and the application server based on K1; and the client host establishing the encrypted Internet communication with the application server based on the encryption and decryption computations.

6. The network security method according to claim 1, characterized in that, step E further comprises: the application server generating a dynamic identifier and a dynamic password and transmitting the dynamic identifier and the dynamic password to the client host through the mobile terminal; the client host transmitting the dynamic identifier and the dynamic password to the application server; the application server allowing the client host to log in; the client host transmitting the user command which is input to the client host to the mobile terminal; the mobile terminal prompting to confirm the user command, and generating a user command ciphertext based on K1 after receiving the confirmation; the client host transmitting the user command ciphertext to the application server, or the client host transmitting the user command to the application server through the encrypted Internet communication in the status of not logging in the application server.

7. The network security method according to claim 1, characterized in that, step F further comprises: the application server transmitting the user command back to the mobile terminal; the mobile terminal confirming that the user command transmitted back by the application server is correct; the application IC card executing mutual authentication with the application server through the mobile terminal; the mobile terminal prompting to input the user command to the mobile terminal or the application IC card, transmitting the input user command to the application server, or the mobile terminal prompting a user to confirm the user command transmitted back by the application server and transmitting the confirmation to the application server.

8. The network security method according to claim 1, characterized in that, step G further comprises: the third-party IC card executing mutual authentication with the third-party server through the mobile terminal; the mobile terminal transmitting the user command digital signature generated by the mobile terminal and/or the third-party IC card to the third-party server; the third-party server generating a time stamp of the user command digital signature and transmitting the time stamp and the user command digital signature to the application server; and the application server executing the user command.

9. The network security method according to claim 1, characterized in that, in all steps of the network security method, the application IC card or the-party IC card complete all functions of both parties independently; the application server or the third-party server complete all functions of both parties independently; the mobile terminal complete all functions of the client host; and the mobile terminal, the third-party IC card, the application IC card and the user command are bound with each other.

10. A network security system, comprising an application IC card, a mobile terminal, a client host, an application server, a third-party IC card and a third-party server;
wherein, the application IC card is connected with the mobile terminal through near field communication (NFC), is used for establishing NFC communication with the mobile terminal and prompting entry of the user command to the application card, executes mutual authentication with the application server through the mobile terminal, establishes encrypted communication, and transmits the input user command to the application server through the encrypted communication; the application IC card is used for executing the mutual authentication with the application server through the mobile terminal after the mobile terminal confirms that the user command fed back by the application server is correct;
wherein, the mobile terminal is connected with the application server and the third-party server through the mobile network, is connected with the client host through a wired communication interface or a wireless communication interface, or communicates with the client host through a QR code, and is used for reading and running mobile terminal system software and mobile terminal application software which are memorized in read-only mode by the mobile terminal, application IC card and/or third-party IC card; the mobile terminal is used for executing the encryption and decryption computations of the encrypted Internet communication between the client host and the application server based on the session secrete key K1; the mobile terminal is used for promoting confirmation of the user command transmitted by the client host, generating a user command ciphertext based on K1 after receiving the confirmation, and transmitting the user command ciphertext to the client host; the mobile terminal is used for, after confirming that the user command transmitted back by the application server is correct, promoting entry of the user command to the mobile terminal or the application IC card, transmitting the input user command to the application server, or promoting the user to confirm the user command transmitted back by the application server, and transmitting the confirmation to the application server; the mobile terminal is used for transmitting the user command digital signature generated by the mobile terminal and/or the third-party IC card to the third-party server;
wherein, the client host is connected with the application server and the third-party server through a digital communication network, and being started, is used for reading and running the client host system software and client host application software memorized in read-only mode by the client host, mobile terminal, application IC card and/or third-party IC card; the client host is used for setting network parameters of the client host, acquiring network parameters of the application server through the mobile terminal, starting the data packet filtering based on the network parameters of the client hot and the application server, wherein the network parameters are IP address, TCP sequence number, TCP port and/or UDP port; the client host is used for establishing the encrypted Internet communication with the application server based on the encryption and decryption computations of the mobile terminal; the client host is used for transmitting a dynamic identifier and a dynamic password to the application server, logging in the application server, transmitting the user command input to the client host to the mobile terminal, and transmitting the user command ciphertext generated by the mobile terminal, or the client host transmits the user command to the application server through the encrypted Internet communication in the status of not logging in the application server;
wherein, the application server is connected with the third-party server through a data communication network, and after being started, is used for reading and running the application server system software and application server application software thereof memorized in read-only mode; the application server is used for establishing encrypted mobile communication with the mobile terminal and allowing the mobile terminal to log in; the application server is used for setting network parameters of the application server, acquiring the network parameters of the client host through the mobile terminal, starting the data packet filtering based on the network parameters of the application server and the client host, wherein network parameters are IP address, TCP sequence number, TCP port and/or UDP port; the application server is used for generating the session secrete key K1 of the encrypted Internet communication between the application server and the client host, and transmitting K1 to the mobile terminal; the application server is used for generating the dynamic identifier and the dynamic password, transmitting the dynamic identifier and the dynamic password to the client host through the mobile terminal; the application server is used for transmitting the user command back to the mobile terminal; and the application server is used for executing the user command;
wherein, the third-party IC card is connected with the mobile terminal through the NFC, is used for executing mutual authentication with the third-party server through the mobile terminal, and is used for generating the user command digital signature;
wherein, the third-party server is used for reading and running the third-party server system software and the third-party server application software thereof memorized in the read-only mode after being started; and, the third-party server is used for generating the time stamp of the user command digital signature, and transmitting the time stamp and the user command digital signature to the application server.

11. The network security system according to claim 10, characterized in that, in the network security system, the application IC card or the-party IC card complete all functions of both parties independently; the application server or the third-party server complete all functions of both parties independently; the mobile terminal complete all functions of the client host; and the mobile terminal, the third-party IC card, the application IC card and the user command are bound with each other.

12. The network security system according to claim 10, characterized in that, in the network security system, a USB Key or a wearable smart device is used to complete all functions of the application IC card and the third-party IC card, wherein the wearable smart device may be a smart watch, a smart band or smart goggles.

13. The network security system according to claim 10, characterized in that, the mobile terminal may be any one of a mobile phone, PDA, tablet computer or notebook computer.

14. The network security system according to claim 10, characterized in that, the application IC card and/or third-party IC card comprises a touch screen; the touch screen is used for displaying and receiving information, and the application IC card and/or third-party IC card be set to work after the touch screen receives a correct command, and the touch screen is powered through NFC.

15. The network security system according to claim 11, characterized in that, in the network security system, a USB Key or a wearable smart device is used to complete all functions of the application IC card and the third-party IC card, wherein the wearable smart device may be a smart watch, a smart band or smart goggles.

16. The network security system according to claim 11, characterized in that, the mobile terminal may be any one of a mobile phone, PDA, tablet computer or notebook computer.

17. The network security system according to claim 11, characterized in that, the application IC card and/or third-party IC card comprises a touch screen; the touch screen is used for displaying and receiving information, and the application IC card and/or third-party IC card be set to work after the touch screen receives a correct command, and the touch screen is powered through NFC.
